(19) United States
(12) Patent Application Publication
(10) Pub. No.: US 2007/0250853 A1
(43) Pub. Date: Oct. 25, 2007

(54) Method and apparatus to configure broadcast programs using viewer's profile

(76) Inventors: Sandeep Jain, Portland, OR (US); Pankaj Garg, Tokyo (JP)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/395,078

(22) Filed: Mar. 31, 2006

(51) Int. Cl. H04N 7/16; H04N 7/025; H04H 9/00

(52) U.S. Cl. 725/28; 725/9; 725/10; 725/34

(57) ABSTRACT

A system includes an image-capturing device to capture an image of a user in a viewing zone. When the user is a registered user, the system is to allow the user to view and hear one or more of the broadcast television programs and the broadcast radio programs based on the user profile information associated with the registered user. When the user is not a registered user, default user profile information may be used.

### FIELD OF INVENTION

The present invention relates generally to the field of digital entertainment, and more specifically, to techniques for configuring broadcast programs.

### BACKGROUND

With the convergence of television and personal computer technologies, new digital entertainment usage models are becoming possible. One example of this convergence is the use of set top boxes that enable consumers to record broadcast programs for replay at a later time. With the aim of capturing the market to enhance consumer entertainment experience, many technology companies have recently announced their commitments to develop and manufacture products that bring the digital entertainment usage models into the homes.

### BRIEF DESCRIPTION OF THE DRAWINGS

The present invention is illustrated by way of example and not limitation in the accompanying figures in which like references indicate similar elements and in which:

FIG. 1 is a block diagram illustrating an example of a computer system, in accordance with some embodiments.

FIG. 2 illustrates an example of a viewing zone, in accordance with some embodiments.

FIG. 3 is a table illustrating an example of user profile information of multiple registered users, in accordance with some embodiments.

FIG. 4 illustrates one implementation example for a computer system that may be configured to determine broadcast programs that a user may prefer to view, in accordance with some embodiments.

FIG. 5 is a block diagram illustrating an example of a process that may be used, in accordance with some embodiments.

### DETAILED DESCRIPTION

For some embodiments, a computer system includes a display that may be used to view broadcast programs. The programs may be television programs. The computer system may be configured to show selective broadcast programs based on viewing profile of a user. The computer system may be used to facilitate a digital home environment.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

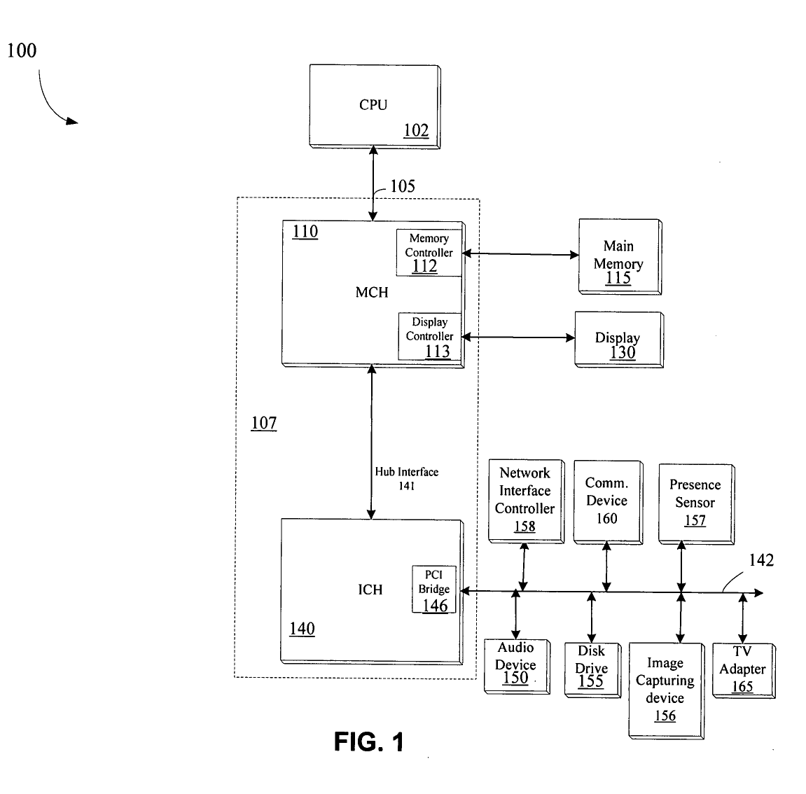

FIG. 1 is a block diagram illustrating an example of a computer system, in accordance with some embodiments. Computer system 100 may be a mobile computer system. Computer system 100 may include a central processing unit (CPU) 102 and may receive its power from an electrical outlet, a battery (not shown), or any other power sources. The CPU 102 and chipset 107 may be coupled to bus 105. The chipset 107 may include a memory control hub (MCH) 110. The MCH 110 may include a memory controller 112 that is coupled to memory 115. The memory 115 may store data and sequences of instructions that are executed by the CPU 102 or any other processing devices included in the computer system 100. The MCH 110 may include a display controller 113.

The chipset 107 may also include an input/output control hub (ICH) 140. The ICH 140 may be coupled with the MCH 110 via a hub interface 141. The ICH 140 may provide an interface to peripheral devices within the computer system 100. The ICH 140 may include PCI bridge 146 that provides an interface to PCI bus 142. The PCI bridge 146 may provide a data path between the CPU 102 and the peripheral devices. In this example, an audio device 150, a disk drive 155, communication device 160, and network interface controller 158 may be connected to the PCI bus 142. The disk drive 155 may include a storage media to store data and sequences of instructions that are executed by the CPU 102 or any other processing devices included in the computer system 100.

Television (TV) Adapter

The broadcast programs in general may include entertainment programs, news programs, advertisements, and any other programs that may be broadcast regardless of transmitting locations. The broadcast programs may include video and audio, video only, or audio only. The broadcast programs may be live or may be pre-recorded. Some of the pre-recorded programs may be stored locally in, for example, the disk drive 155.

For some embodiments, a TV adapter 165 may also connected to the PCI bus 142. The TV adapter 165 may be coupled to the display controller 113 and may enable receiving broadcast programs. The TV adapter 165 may be a modular device and may be able to receive digital signals. In a digital home entertainment environment, the TV adapter 165 may enable a user to view broadcast programs on the display 130. One advantage of using the TV adapter 165 is the ability to prolong the use of the computer system 100 and the display 130, which may be applicable in some situations.

For some embodiments, the logic in the TV adapter may be integrated into the system board (not shown) or into other components (e.g., the display controller, etc.) internal or external to the computer system 100.

Although not shown, the computer system 100 may include logic to record and store broadcast programs and logic to retrieve the stored broadcast programs. It is envisioned that the broadcast programs may be received via any transmission medium (e.g., satellite, airwave, cable, Internet, personal area network (PAN), etc.).

Detection Sensor and Image Capturing Device

For some embodiments, a sensor 157 may also be connected to the PCI bus 142. The sensor 157 may be used to detect presence of a user. The sensor 157 may be an acoustic sensor, a heat sensor, a motion sensor, or any other type of sensor that may be used to detect presence of a user in an area within a vicinity of the computer system 100.

For some embodiments, an image capturing device (e.g., digital camera, video camera, etc.) 156 may be connected to the PCI bus 142. The image capturing device 156 may be coupled to the display 130 and may be used to capture an image in front of the display 130. An image captured by the image capturing device 156 may be analyzed by image analysis logic (not shown) in the computer system 100 to determine the identity of the user detected to be in front of the display 130. The image analysis logic may be implemented in hardware, software or a combination of both hardware and software.

For some embodiments, the functions performed by the sensor 157 and by the image capturing device 156 may be performed by a single device (not shown) such that sensing and image capturing may be performed almost simultaneously to increase efficiency. As will be described, the combination of the functions performed by the image capturing device 156 and by the sensor 157 may enable the computer system 100 to determine the broadcast programs that a user may prefer to view.

Viewing Zone

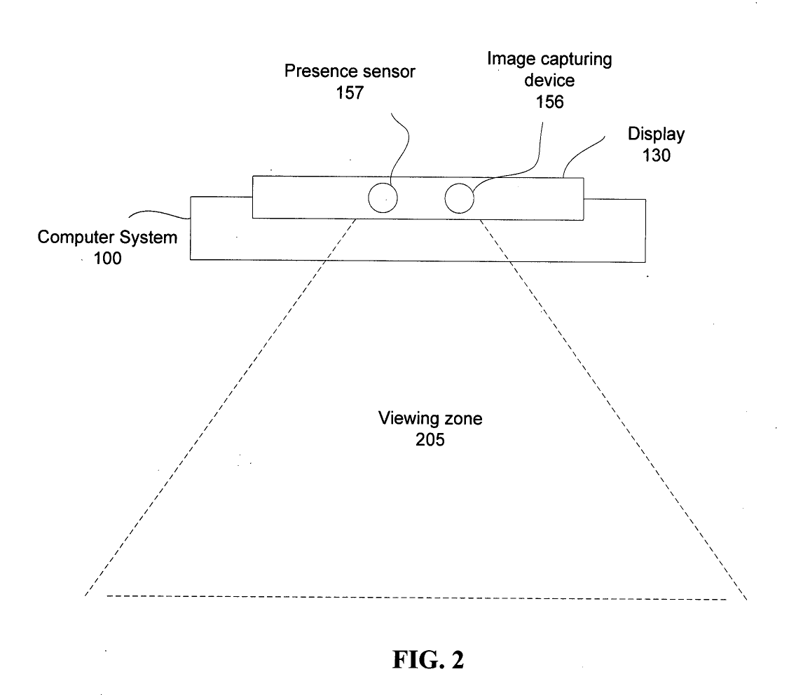

FIG. 2 illustrates an example of a viewing zone, in accordance with some embodiments. The sensor 157 may be configured to detect presence of a user when the user is positioned inside a viewing zone 205. Generally, the viewing zone 205 may include an area in front of the display 130. It may be noted that the viewing zone 205 is illustrated as an example. Because one or more sensors similar to the sensor 157 may be used, size of the viewing zone 205 may vary.

For some embodiments, the image capturing device 156 may be configured to capture an image that covers most or the entire viewing zone 205. This way, when the sensor 157 detects presence of a user in the viewing zone 205, the image captured by the image capturing device may likely include an image of the user. It may be noted that there may be multiple users positioned within the viewing zone 205. As such, the image may include images of more than one user.

User Registration

For some embodiments, each user is to be registered with the computer system to form a user community. For example, this may be performed when the computer system 100 is placed in operation. The registration process may include positioning the user in the viewing zone 205 and having an image of the user captured by the image capturing device 156. Alternatively, an image of a user captured by a different image capturing device may be provided by the user. For example, the registration process may also include entering the user's age, name (or nickname), or some form of identification to associate with the user's image. After the initial registration process, new users may be added or deleted to reflect changes in the user community. The images of the users may be stored in the computer system 100 and may be used by the computer system 100 to perform user recognition operations. For some embodiments, the registration process may be performed with a user who has registration authorization. In a digital home environment, one or both parents may have the registration authorization. This person may be referred to herein as an administrator. For some embodiments, the administrator has all rights and authorization to configure the computer system 100.

User Group

For some embodiments, the registered users may be grouped in one or more groups. Each group may include users that have some common characteristics. For example, one group of users may include all users under the age of ten (10). One group of users may include all users over the age of twenty five (25). One group of users may include all users that enjoy sport programs. One group of users may include both parents, and so on.

User Profile

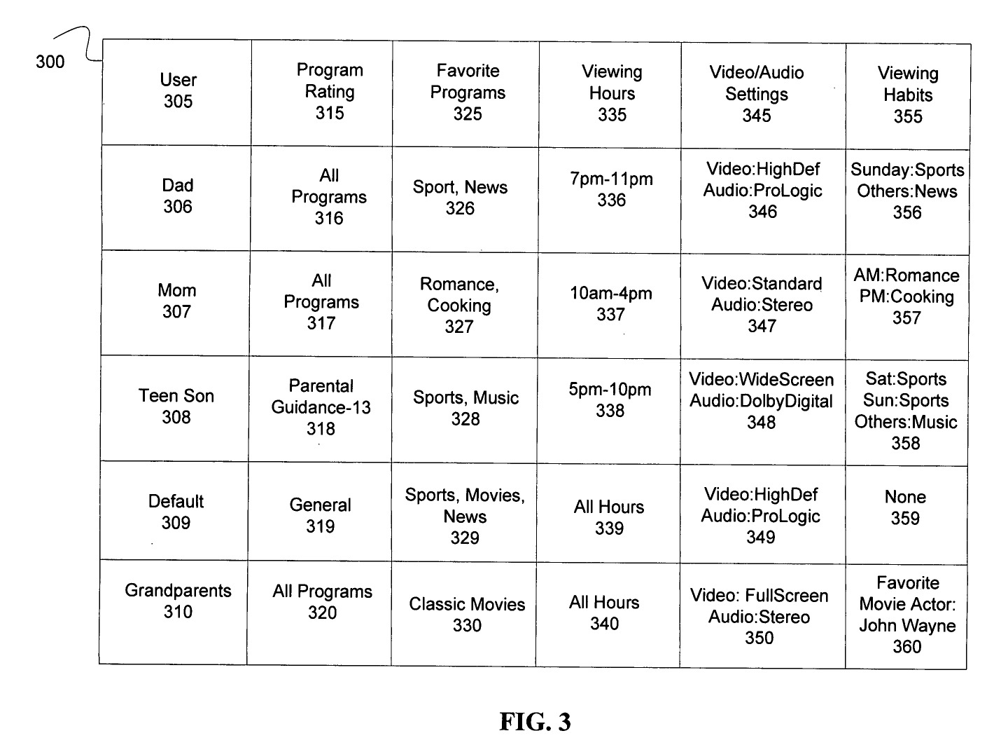

FIG. 3 is a table illustrating an example of user profile information of multiple registered users, in accordance with some embodiments. For some embodiments, each registered user is associated with a user profile. The user profile may include information unique to the user. Table 300 illustrates user profile examples for members of a family including users 306-310 and corresponding program ratings 316-320, favorite programs 326-330, viewing hours 336-340, video/audio settings 346-350, and viewing and/or listening habits 356-360. Depending on the user, some user profile may allow more access or permission than others. For example, a teen age son user 308 may be given permission to view a subset of the all programs. The subset may include only programs that are rated as parental guidance-13 (PG-13), while user Dad 306 may have permission to view all programs 316. As another example, user group Grandparents 310 may be given permission to view programs of all ratings.

The user profile information may be specified during the registration process. For some embodiments, the user profile may also include data that is automatically collected based on the viewing habit of the user. The data may be collected over a period of time and analyzed to determine the viewing habit of the user. The user profile may subsequently be updated. Updating the user profile may be performed by the administrator.

Default User Profile

For some embodiments, non-registered user or a guest user may be allowed to view some of the broadcast programs. This may require the administrator to set up a default user profile information 309. For example, the default user profile information 309 may include the following information: Program Rating: General (G) 319; Favorite Programs: Sports, Movies, News 329; Viewing Hours: All Hours 339; Video/Audio Settings: High Definition/Pro Logic; Viewing Habits: None 359. When the computer system 100 does not recognize a user or a group of users detected in the viewing zone 205, the default user profile may be used to determine the programs that can be shown.

Super User

As noted above, it may be possible that there may be multiple registered users within the viewing zone 205, and the image captured by the image capturing device 156 may include images of more than one user. For some embodiments, at least one user among all of the registered users known by the computer system 100 is designated as a super user. The super user may be a user that has higher authority than all of the other users present in the viewing zone 205. For some embodiments, whenever a super user is detected to be within the viewing zone 205, the user profile of the super user may prevail over the user profile of all of the other users. The administrator may be a super user.

For some embodiments, when a group of users are in the viewing zone 205 and only one user is a registered user, that user becomes the super user. That is, the user profile information of that registered user may be used over the default user profile information.

Implementation Example

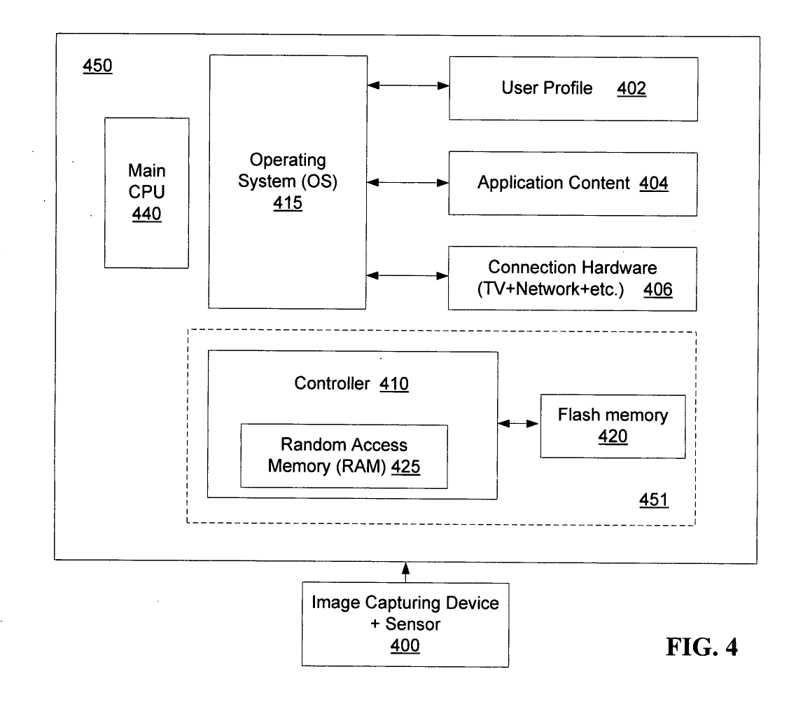

FIG. 4 illustrates one implementation example for a computer system that may be configured to determine broadcast programs that a user may prefer to view, in accordance with some embodiments. Computer system 450 may be configured to operate with main processor 440 and a main operating system (OS) 415. The computer system 450 may also include a controller circuit 451 comprising a controller 410 and flash memory 420. The controller circuit 451 may be included in the computer system 450, or it may be included in a separate device (e.g., set top box).

For some embodiments, the controller 410 may be a dedicated controller. For some other embodiments, the controller 410 may be part of the graphics and memory controller (GMCH) or the input/output controller (ICH). The controller 410 may have its own dedicated power source (e.g., a battery), and it may stay in a low power mode until it needs to perform image analysis. The controller 410 may be associated with an operating system (e.g., embedded Linux).

The flash memory 420 may store images of one or more registered users and may be accessed by the controller 410 via one or more signal lines (e.g., clock, data, etc.). The images may be facial images. Other types of images that enable user recognition may also be used. The images may need to be updated frequently to include data for a new user or to include data to reflect changes to the facial image of an existing user. The controller circuit 451 may include memory (e.g., random access memory) 425 and may be coupled to device 400.

For some embodiments, the device 400 may include circuitry to detect user presence (as a sensor) and to initiate an interrupt to power up the controller 410. When no one is using the computer system 450 or is within the viewing zone 205, the device 400 may remain active to perform periodic monitoring for a user to come within the viewing zone 205. When a user is detected by the device 400, an interrupt may be sent to the controller 410.

User Recognition

For some embodiments, after the device 400 sends the interrupt, it may capture an image of the detected user and send that image to the controller 410 to perform user recognition functions. The controller 410 may access stored images from the flash memory 420. The controller 410 may analyze data captured by the device 400 to recognize a user. The controller 410 may need to separate individual facial image when there are more than one user. User recognition information may be processed by the main processor 440. The controller 410 may provide a low power approach to detect and analyze a user while the main processor 440 is in a low power mode. In addition, it is possible to save display power consumption by not powering on the display 130 (or keeping it in a low power mode) until at least after user presence is detected. Keeping the display powered off or in a low power mode may be also be advantageous by extending the life of the display 130.

Program Selection and Program Filter

The computer system 450 may store the user profile in user profile database 402. The computer system 450 may also store pre-recorded programs in a program content database 404. Although not shown, the user profile database 402 and the program content database 404 may be stored in the same storage device or various storage devices.

When the user is recognized by the controller 410, the user information may be sent to the main processor 440 to retrieve the appropriate user profile information from the user profile database 402. Based on the retrieved user profile information, the main processor 440 may perform program selection operations to select appropriate programs from the program content database 404. The program selection operations may also select programs via connection hardware 406. The connection hardware 406 may be used to enable connection or access to broadcast programs via any transmission medium (e.g., satellite, airwave, cable, Internet, PAN, etc.). The selected programs may then be presented to the user on a display/television (e.g., display 130 in FIG. 1). As described above, when a super user is recognized among a group of users, the user profile of the super user may be used.

For some embodiments, to provide a layer of filtering to the program selection process, a program filter may be applied based on the user profile information. Filtering rules may need to be specified by the administrator. For example, the filtering rules may include a rule that prevent users younger than 18 to view programs that have ratings of “R” and to prevent users younger than 12 to view programs that have ratings of “PG-13”. The filtering rules may include a rule that prevent all viewers younger than 16 to view any programs after 10 p.m. on a weekday, etc. Thus, depending of the recognized user, the program filter may dynamically apply the appropriate rules. When the super user is recognized to be present in the viewing zone, the program filter may apply filter rules, if any, applicable to the super user. Since the administrator may be a parent in a family, the filtering rules may be viewed as a technique for parents to apply parental locking to the system.

It may be noted that the program selection operations and the program filter may be implemented in hardware, software or a combination of both hardware and software. Although the example above describes having the controller 410 performing the user recognition operations, it is also possible in alternative embodiments to have the main processor 440 performing similar operations.

Process

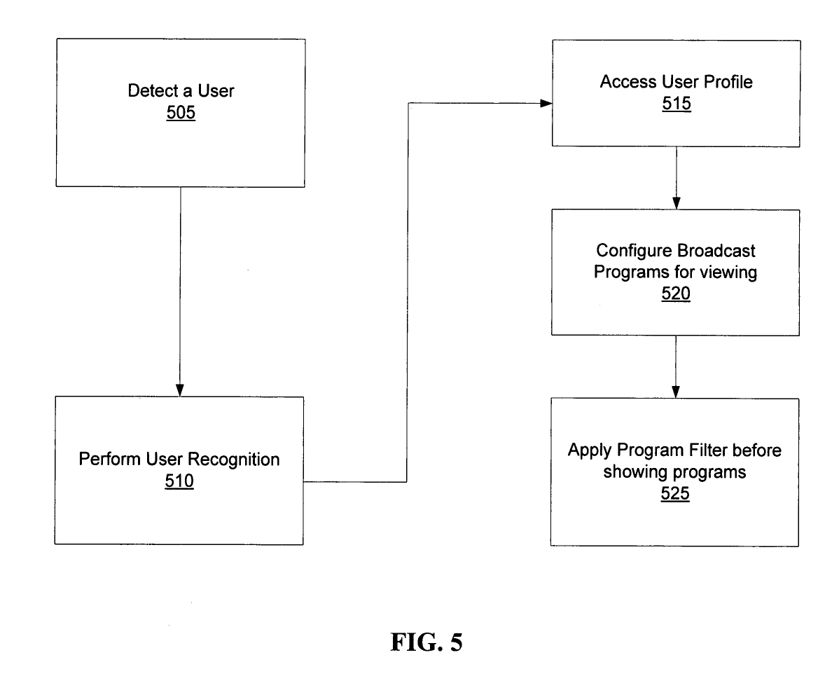

FIG. 5 is a block diagram illustrating an example of a process that may be used, in accordance with some embodiments. In this example, the process is performed after a user enters the viewing zone 205. At block 505, the user is detected by the user detection sensor. A signal may be sent to notify the controller 410. At block 510, the controller 410 may perform user recognition operations. This may involve comparing image data. Once the user is recognized, the process flows to block 515, where the user profile for the user is retrieved from the user profile database 402. Using the user profile, appropriate programming is determined, as shown in block 520. At block 525, program filtering may be applied based on the user profile information before the program is shown on a display. The program may be shown to the user on a display or a television coupled to the computer system 100. It may be noted that the display may not be turned on until after the user is recognized. This may be advantageous because it may help prolonging the life of the display and reducing the power consumption associated with the display.

Although some embodiments of the present invention have been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method, comprising:
performing user recognition of one or more users to identify user profile information; and
determining broadcast programs to show based on the user profile information.

2. The method of claim 1, further comprising:
detecting presence of the one or more users in a viewing zone;
capturing an image of the one or more users in the viewing zone; and
comparing the image of the one or more users with stored images of registered users.

3. The method of claim 2, wherein when there is only one user in the image and the user is a registered user, user profile information of the registered user is used to determine the broadcast programs.

4. The method of claim 3, wherein when there are two or more registered users in the image, user profile information of a registered user having higher authority is used to determine the broadcast programs.

5. The method of claim 4, wherein the user profile information of a registered user is unique.

6. The method of claim 5, wherein the user profile information of a registered user includes viewing preferences.

7. The method of claim 5, wherein the user profile information includes viewing habit.

8. The method of claim 4, wherein when none of the one or more users is a registered user, a default user profile information is used to determine the broadcast programs.

9. The method of claim 2, further comprising:
performing user registration, wherein the user registration includes capturing an image of a user, storing the image of the user, and generating the user profile information unique to the user.

10. An apparatus, comprising:
a controller;
a sensing and image-capturing device coupled to the controller to sense presence of one or more users in a viewing zone and to capture an image of the one or more users; and
a first storage device coupled to the controller to store images of one or more registered users, wherein the controller is to compare the image of the one or more users in the viewing zone with the stored images to determine if the one or more users in the viewing zone includes at least one registered user, and wherein the controller is to generate a comparison result to be used to determine user profile information and to determine broadcast programs based on the user profile information.

11. The apparatus of claim 10, further comprising:
a second storage device to store user profile information for one or more registered users and a default user profile information for a guest user; and
a content database coupled to the second storage device to store broadcast programs.

12. The apparatus of claim 11, further comprising:
a program selection logic coupled to the content database to determine the broadcast programs based on the user profile information.

13. The apparatus of claim 12, wherein when the comparison result generated by the controller indicates that a registered user is included in the one or more users in the viewing zone, user profile information of that registered user is used by the program selection logic.

14. The apparatus of claim 13, wherein when the comparison result generated by the controller indicates that no registered user is included in the one or more users in the viewing zone, the default user profile information is used by the program selection logic.

15. A system, comprising:
a processor;
a display coupled to the processor;
an adapter coupled to the processor and configured to receive broadcast television programs; and
a first database coupled to the processor, the first database storing user profile information associated with registered and non-registered users, wherein the processor is to enable at least a subset of the broadcast television programs to be shown on the display using selected user profile information.

16. The system of claim 15, wherein the adapter is further configured to receive broadcast radio programs, and wherein the processor is further to enable at least a subset of the broadcast radio programs to be played based on the selected user profile information.

17. The system of claim 15, further comprising:
a controller coupled to the processor;
a second database coupled to the controller, wherein the second database is to store images of one or more registered users; and
an image-capturing device coupled to the controller, wherein the image-capturing device is to capture an image of one or more users in a viewing zone, and wherein the controller is to compare the image with data in the second database to determine if the one or more users in the viewing zone includes a registered user, wherein when all of the one or more users in the viewing zone are non-registered users, the processor is to use default user profile information, wherein when there is at least one registered user in the viewing zone, the processor is to use user profile information associated with that registered user.

18. The system of claim 17, wherein when there is more than one registered user in the viewing zone, the processor is to use user profile information of a registered user having highest authority among all of the registered users in the viewing zone.

19. The system of claim 18, further comprising:
a sensor coupled to the controller, wherein the sensor is to sense presence of the one or more users in the viewing zone.

20. The system of claim 19, wherein the processor is placed in a low power state until after the sensor detects the presence of the one or more users in the viewing zone.

21. The system of claim 20, wherein the display is placed in a low power state until after the sensor detects the presence of the one or more users in the viewing zone.

22. The system of claim 15, further comprising a program content database coupled to the processor, wherein the program content database is to store recorded broadcast television programs, and wherein the processor is to enable at least a subset of the recorded broadcast television programs to be shown on the display using the selected user profile information.

23. The system of claim 22, wherein the processor is to further filter programs to be shown on the display based on user profile information and filtering rules.
